(19) United States
(12) Patent Application Publication
(10) Pub. No.: US 2009/0037397 A1
(43) Pub. Date: Feb. 5, 2009

(54) METHODS AND APPARATUS FOR PROVIDING CONTEXT SEARCH RESULTS IN PROCESS DESIGN

(75) Inventors: Olaf Wagner, Issaquah, WA (US); Anthony Petro, Centennial, CO (US)

Correspondence Address: BELL, BOYD & LLOYD, LLP, P.O. Box 1135, CHICAGO, IL, 60690, US

(73) Assignee: SourceCode Technology Holding, Inc., Redmond, WA (US)

(21) Appl. No.: 12/115,279

(22) Filed: May 5, 2008

Related U.S. Application Data
(60) Provisional application No. 60/939,267, filed on May 21, 2007.
(60) Provisional application No. 60/915,832, filed on May 3, 2007.

(51) Int. Cl. G06F 17/30; G06F 3/048

(52) U.S. Cl. 707/4; 707/3; 715/700

(57) ABSTRACT

The present disclosure provides methods and apparatuses for providing context search results in process design. Using the methods and apparatus herein, users can use a list of dynamic content from a variety of sources, determined at runtime and based on criteria that can change dynamically at runtime, in their process design. With the content, the users can create process steps that act on the dynamically chosen content as a single entity

### CROSS-REFERENCE TO RELATED APPLICATIONS

The present application claim benefit to U.S. Patent Application No. 60/915,832, METHODS AND APPARATUS FOR INCLUDING SEARCH RESULTS IN A WORKFLOW PROCESS, filed May 3, 2007; and U.S. Patent Application No. 60/939,267, METHODS AND APPARATUS FOR PROVIDING CONTENT SEARCH RESULTS IN PROCESS DESIGN, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Business can now also incorporate business process design into their existing technology systems. Instead of providing a simple map of a business process, integration with computer systems allows business process designers to design interactive business processes that drive business workflow. Business process designers can receive data from various sources, perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Businesses often need to perform a set of actions on content, such as documents or list items. Most of the content involved in these processes is typically identified on a one-to-one basis, for example performing an approval process when a document is added to a storage location. However, business process designers would often rather build a process with a list of dynamic content that results from searching across stored documents. For example, performing authorization on documents that have been edited in the last twenty four hours. Currently, there is no convenient way to perform a process in business process workflow on a group of dynamically chosen documents or items as a single entity.

### SUMMARY

The present disclosure provides methods and apparatuses for providing context search results in process design. Using the methods and apparatus herein, users can use a list of dynamic content from a variety of sources, determined at runtime and based on criteria that can change dynamically at runtime, in their process design. With the content, the users can create process steps that act on the dynamically chosen content as a single entity

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is a screenshot of an example process.

FIG. 5 is a screenshot of an example action selection page.

FIG. 6 is a screenshot of a example source page.

FIG. 7 is a screenshot of an example query page.

FIG. 8 is a screenshot of an example search parameter page.

FIG. 9 is a screenshot of an example search results page.

### DETAILED DESCRIPTION

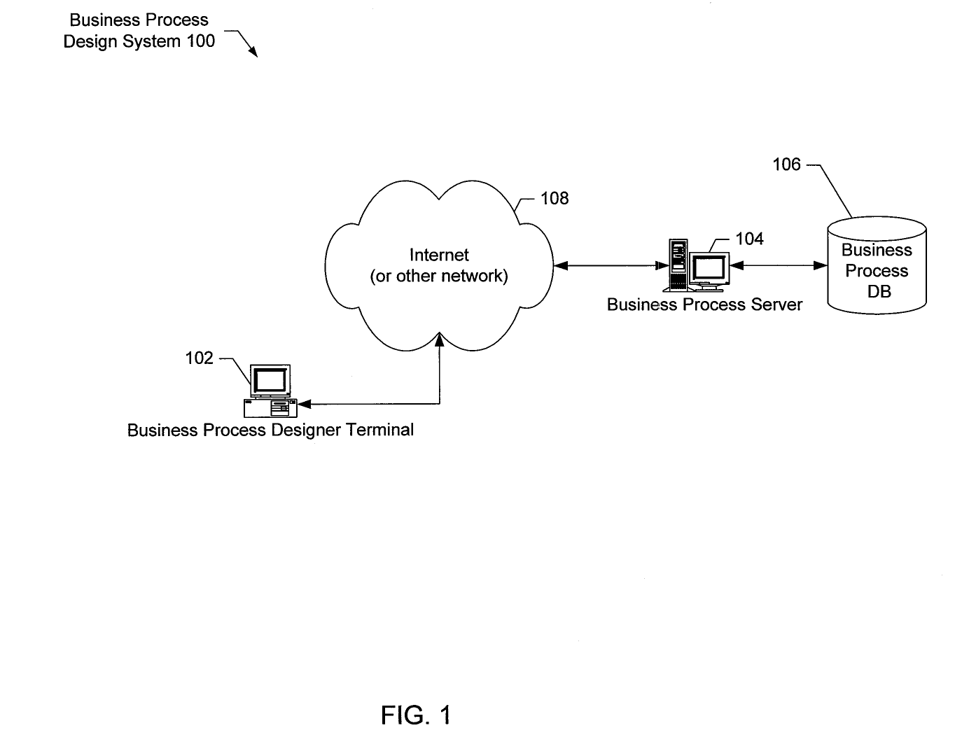

The present system is most readily realized in a network communications system. A high level block diagram of an business process design system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

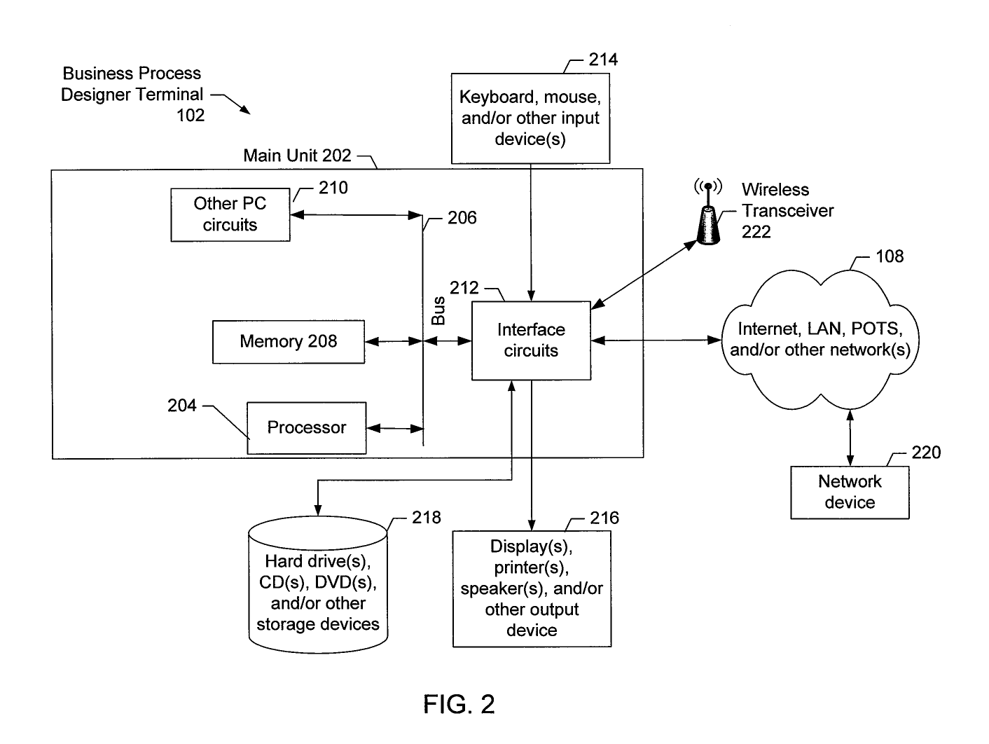

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

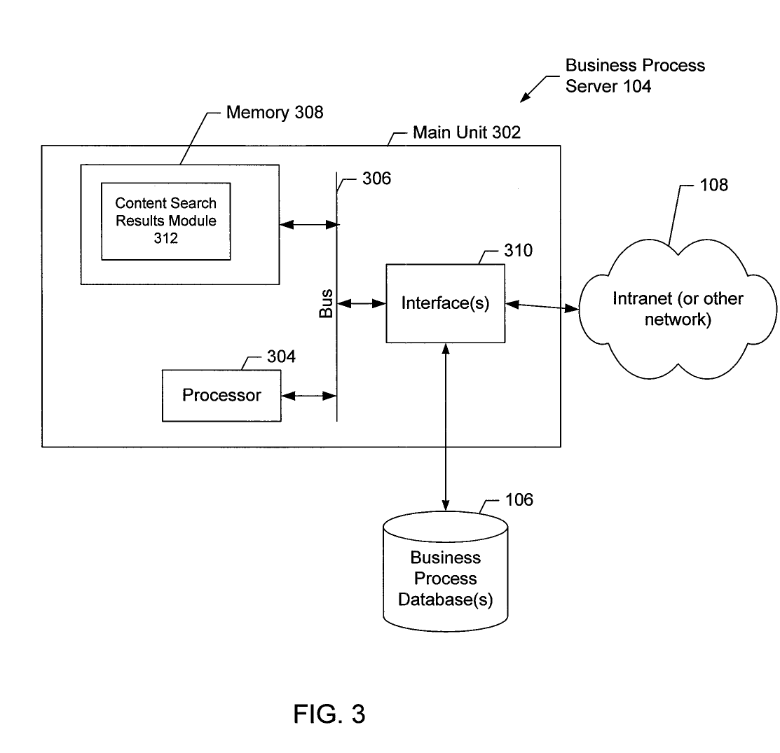

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory. Preferably, the memory device 308 stores a software program that implements all or part of the method described below.

In particular, the memory 308 preferably stores a content search results module 312. The content search results module 312 may store the criteria for a document or list search. For example, a business process designer may wish to create a process that uses all documents that were modified longer than one year earlier from the time the process is run and that have a “Final” status. The content search results module 312 may communicate with the business process database 106 to store the search criteria.

The content search results module 312 performs the search during the process execution. For example, when the process is run, the content search results module 312 may communicate with the business process database 106 to retrieve the appropriate documents. In another example, the content search results module 312 communicates with other data sources, such as other servers, other databases, etc., in order to retrieve documents that correspond to the search criteria. The search criteria may by representative of the search object. For example, the search criteria may include searching on strings, numbers, logical objects, etc. The search results are provided at runtime and therefore are a dynamic listing of documents, not a hard-coded listing of existing documents or a pre-set folder of documents. Additionally, the search criteria may be modified at runtime, allowing for changes without the need to stop and restart the process.

The content search results module 312 may also assist a business process designer in creating a content search through the use of a wizard. For example, the content search results module 312 may transmit wizard data to the business process designer terminal 102 that provides an easy interface for creating a content search at an appropriate point of the business process. The content search results module 312 may interrogate a repository, for example a server, and present the business process designer with options that define the source and the scope of the search. For example, the business process designer may decide that the source of the search will be a remote database and that the scope will be all of the records. The business process designer may have access to related business entities and business policies so that the correct field names and values are available for creating the criteria. For example, the business process designer may wish to retrieve all of the documents sent by a client. In this example, the business process designer will have access to the “Client Name” field of the “Client” business entity and the business process designer will be able to use the field in constructing a content search. The content search results module 312 may store the results in the business process database 106, or another storage medium, as process data fields or business entities.

At runtime, the content search results module 312 may create a pointer to documents and list items matching the search criteria either at the beginning of the process or the business process step where the document or list items are called. The pointer may then be passed to the process for use in the business process step that requires the documents or list items. This allows for a dynamic process design that can work with sets of documents and list items that are changing based on the process data at any point in time.

The content search results module 312 also allows for business entity values to be mapped onto search fields, and at runtime evaluate the business entities to determine what values should be used. For example, the business process designer can map the “CLIENT NAME” field from the “CLIENT” business entity to the “NAME SEARCH” field for the search criteria. During run time the “CLIENT” business entity will be selected and the “CLIENT NAME” will be determined and used for the search.

The results may be converted into a data structure, such as XML, etc. The converted data structure may then be stored for use in other places in the overall process design. For example, the task “Copy Documents Matching Search Results to This Location,” may require the converted data structure. The data structure will contain pointers to the content. In some instances, it may be required to store the content for auditing purposes and that can be done.

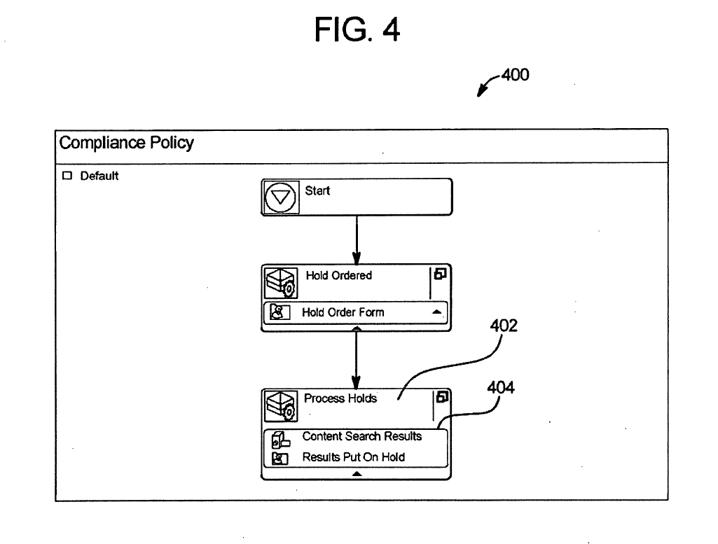

A screenshot of an example process 400 is presented in FIG. 4. Although the example process 400 is described in reference FIG. 4, it will be appreciated that many other configurations are possible. For example, elements could be in different locations, elements could have different names, and/or elements could have different graphical representations.

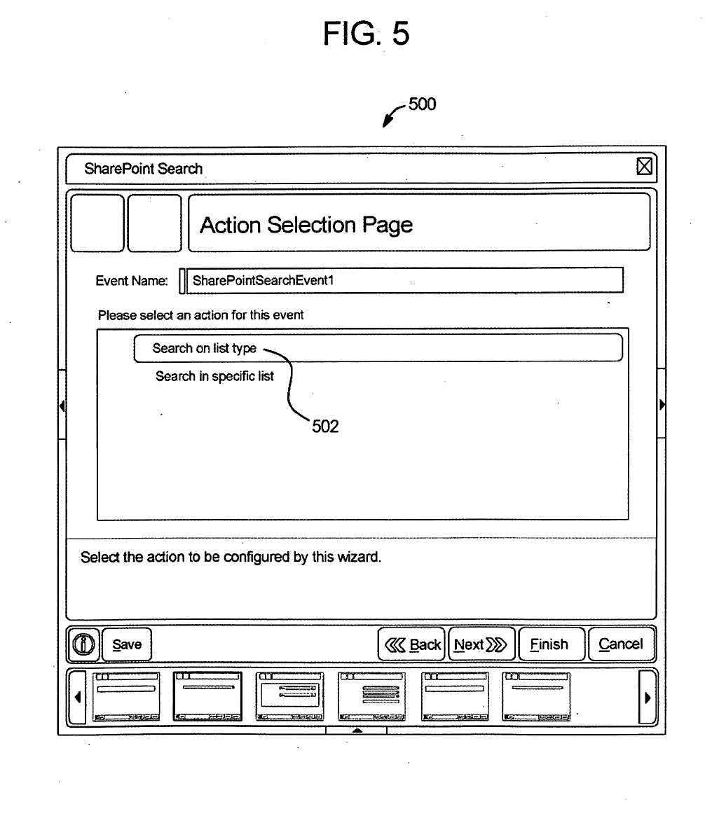

The example process 400 has a process holds activity 402. The process holds activity 402 is a process to handle “holds” that have been ordered from a previous business process activity. The “holds” may require certain content such as order numbers. The content may be provided by a content search results event 404. The business process designer may select to define the content search results event 404 and wizard data may be transmitted by the content search results module 312 to the business process designer terminal 102. The wizard is explained in further detail in relation to FIGS. 5-9.

A screenshot of an example action selection page 500 is presented in FIG. 5. Although the example action selection page 500 is described in reference FIG. 5, it will be appreciated that many other configurations are possible. For example, elements could be in different locations, elements could have different names, and elements could have different graphical representations.

A process designer may configure the content search through a series of wizard-driven questions. The wizard may interrogate the business process server 104, the business process database 106, and/or another repository of the business process system. The action selection page 500 may allow the business process designer to determine the type of the search. For example, the business process designer may be presented with a list 502 to determine the type of the search based on the document, content list type or the location of the item.

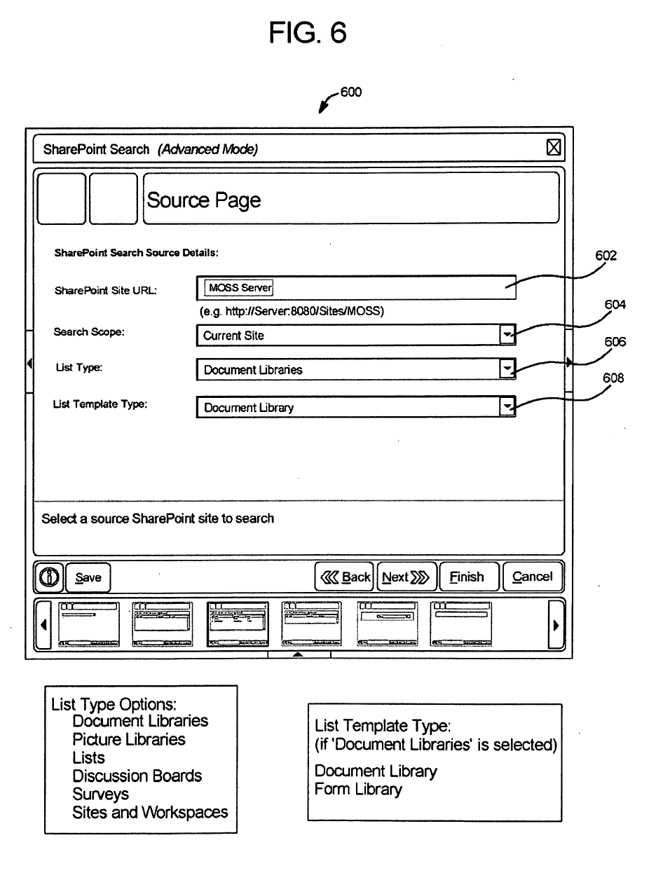

A screenshot of an example source page 600 is presented in FIG. 6. Although the example action source page 600 is described in reference FIG. 6, it will be appreciated that many other configurations are possible. For example, elements could be in different locations, elements could have different names, and elements could have different graphical representations.

The source page 600 may allow the business process designer to select the scope of the search, such as a repository, depth of search, list type, list template, etc. For example, see FIG. 6, showing options for repository 602, depth of search 604, list type 606, and list template 608. The repository 602 may specific the location where the search will take place. For example, the business process designer may enter a url designating a server location in the repository 602 field. The depth of search 604 may provide options to the business process designer for the scope of the search. For example, the business process designer may be able to select “Entire Site” as the scope of the search. In another example, the business process server 104 may retrieve information regarding the repository 602 and provide specific servers, databases, tables, etc. for the user to choose. The list type 606 may provide options for the types of libraries to be searched. For example, list type 606 may include document libraries, picture libraries, lists, discussion boards, surveys, sites and workplaces, etc. The list template 608 may be options related to the list type 606 and provide options for how the content search results should be provided. For example, if the list type 606 is “document libraries,” the list template 608 may be “document library,” “form library,” etc.

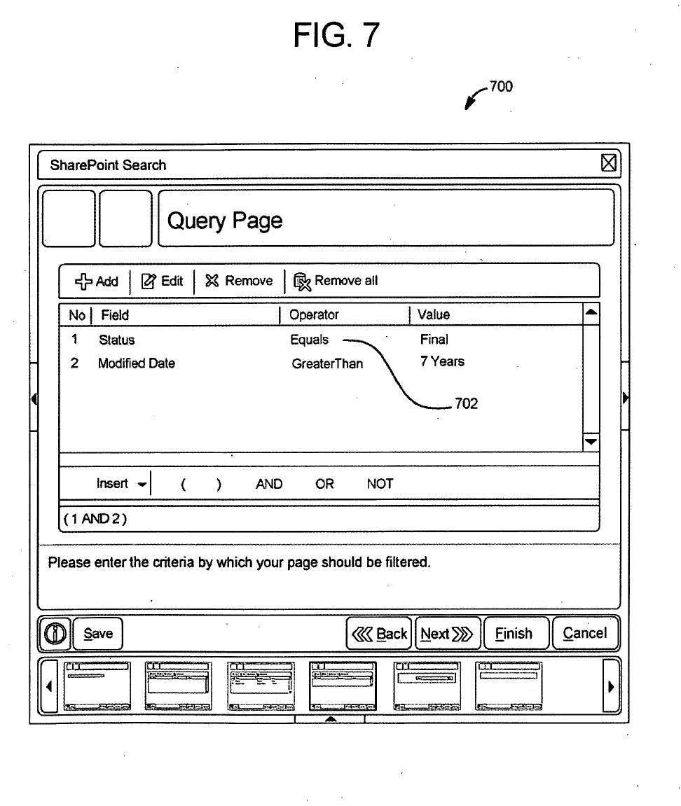

A screenshot of an example query page 700 is presented in FIG. 7. Although the example action query page 700 is described in reference FIG. 7, it will be appreciated that many other configurations are possible. For example, elements could be in different locations, elements could have different names, and elements could have different graphical representations.

The business process designer may be presented a query page 700 based on data associated with the selected documents or lists. After selecting the data source and search criteria on the search page 600, the business process designer may be presented with a query page 700 where the options for the query are restricted to fields, values, operations, etc. based on data associated with the documents or lists. The business process designer may select to search for a document based on a “modified date” field, related to the documents available from the search. The content search results module 312 may display only the criteria that would be available based on the search. For example, an “image size” criteria may only be available if the search results included pictures.

The query page 700 may contain an interface for easy creation of multiple criteria. The query page 700 may contain a section to create individual search criteria 702. The query page 700 may also contain a section to allow for Boolean operations to be performed on multiple criteria 704. The query page 700 may contain graphics to aid in the creation of the criteria, where the graphics correspond to common logic elements.

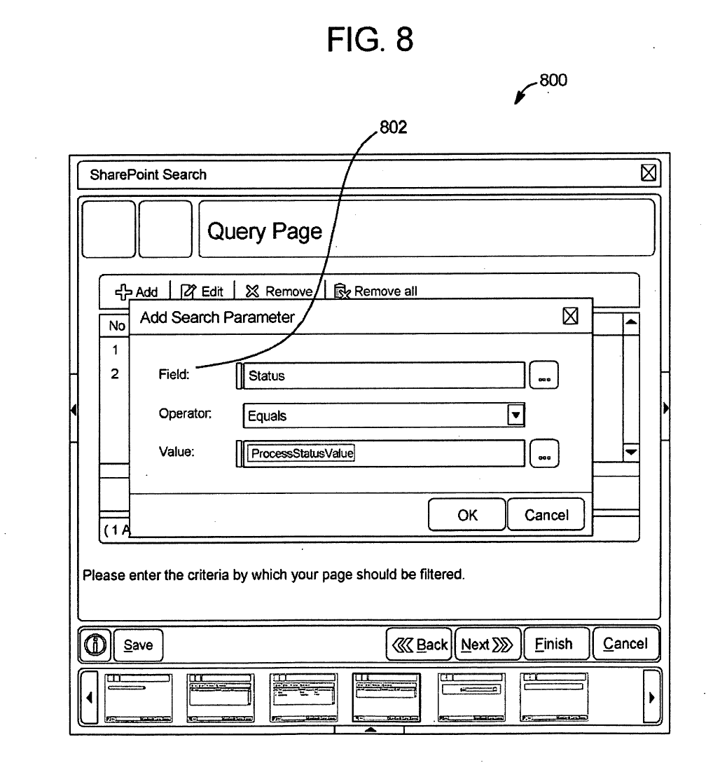

A screenshot of an example search parameter page 800 is presented in FIG. 8. Although the example action search parameter page 800 is described in reference FIG. 8, it will be appreciated that many other configurations are possible. For example, elements could be in different locations, elements could have different names, and elements could have different graphical representations.

Additionally, information from the overall process may be provided as input values to the query. For example, a “Status =[ProcessStatusValue]” query 802 could be a valid criteria. “ProcessStatusValue” would be determined at runtime and would be related to the status of the overall business process when the search is made.

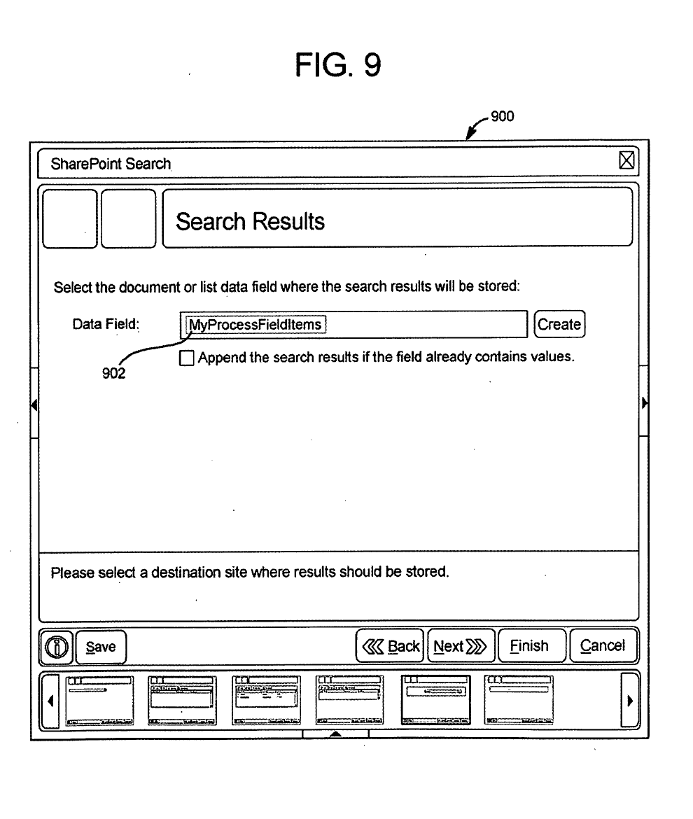

A screenshot of an example search results page 900 is presented in FIG. 9. Although the example action search results page 900 is described in reference FIG. 9, it will be appreciated that many other configurations are possible. For example, elements could be in different locations, elements could have different names, and elements could have different graphical representations.

A search results page 900 may be displayed to the business process designer. The search results page may allow the business process designer to designate a field to store the results of the content search so that they may be accessed later in the process. For example, the user may be presented with a data field input 902 to enter a name for the content search results.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for providing context search results in business process design, the method comprising:
creating a workflow;
creating a context search result object, wherein the workflow includes the search result object and the context search result object includes a list of content;
selecting a search source associated with the context search result object;
creating a search criteria, wherein the search criteria is based on the search source and associated with the context search result object; and
executing the workflow, wherein executing the workflow includes determining the context search result object.

2. The method of claim 1, wherein the search criteria includes a data type associated with the search object.

3. The method of claim 1, wherein the search source is an external system.

4. The method of claim 1, wherein creating search criteria includes retrieving search options based on the search source, and presenting the search options.

5. The method of claim 1, including presenting a graphical user interface for creating a search criteria.

6. The method of claim 5, wherein the graphical user interface includes a graphical representation of a logic element.

7. A system for providing context search results in business process design, the system comprising:
a processor for:
creating a workflow;
creating a context search result object, wherein the workflow includes the search result object and the context search result object includes a list of content;
selecting a search source associated with the context search result object;
creating a search criteria, wherein the search criteria is based on the search source and associated with the context search result object; and
executing the workflow, wherein executing the workflow includes determining the context search result object.

8. The system of claim 7, wherein the search criteria includes a data type associated with the search object.

9. The system of claim 7, wherein the search source is an external system.

10. The system of claim 7, wherein creating search criteria includes retrieving search options based on the search source, and presenting the search options.

11. The system of claim 7, including presenting a graphical user interface for creating a search criteria.

12. The system of claim 11, wherein the graphical user interface includes a graphical representation of a logic element.

13. A computer readable medium storing instructions to cause a computing device to:
create a workflow;
create a context search result object, wherein the workflow includes the search result object and the context search result object includes a list of content;
select a search source associated with the context search result object;
create a search criteria, wherein the search criteria is based on the search source and associated with the context search result object; and
execute the workflow, wherein executing the workflow includes determining the context search result object.

14. The computer readable medium of claim 13, wherein the search criteria includes a data type associated with the search object.

15. The computer readable medium of claim 13, wherein the search source is an external system.

16. The computer readable medium of claim 13, wherein the instructions to cause a computing device create search criteria by retrieving search options based on the search source, and present the search options.

17. The computer readable medium of claim 13, including present a graphical user interface for creating a search criteria.

18. The computer readable medium of claim 17, wherein the graphical user interface includes a graphical representation of a logic element.
